(19) United States
(12) Patent Application Publication
(10) Pub. No.: US 2006/0044426 A1
(43) Pub. Date: Mar. 2, 2006

(54) Image pickup device having a plurality of solid-state image pickup elements

(76) Inventor: Takashi Tanimoto, Gifu (JP)

Correspondence Address: HOGAN & HARTSON L.L.P., 500 S. GRAND AVENUE, SUITE 1900, LOS ANGELES, CA, 90071-2611, US

(21) Appl. No.: 10/532,417

(22) PCT Filed: Nov. 25, 2003
(86) PCT No.: PCT/JP03/14971

§ 371 Date: Apr. 22, 2005

(30) Foreign Application Priority Data
Nov. 26, 2002 (JP) 2002-342659

(51) Int. Cl. H04N 9/09

(52) U.S. Cl. 348/262

(57) ABSTRACT

A first solid-state image pickup element accumulates first information electric charge generated in response to a first object image in a plurality of light reception pixels. As first drive circuit drives the first solid-state image pickup element to obtain a first image signal. A second solid-state image pickup element accumulates second information electric charge generated in response to a second object image in a plurality of light reception pixels. A second drive circuit derives the second solid-state image pickup element to obtain a second image signal. A selector circuit selectively supplies a predetermined voltage V_{OH} in synchronization with the operation timing of the first and the second solid-state image pickup element.

### TECHNICAL FIELD

The present invention relates to an image pickup device which images a plurality of object images by using a plurality of solid-state image pickup elements, combines image signals of a plurality of systems obtained thereby and outputs a combined signal.

### BACKGROUND ART

In an image pickup device such as a digital still camera, there have been considered mounting a plurality of solid-state image pickup elements in order to image a plurality of object images, combining image signals of a plurality of systems obtained thereby and displaying a combined signal on a common display screen (see Japanese Application: Japanese Patent Application Laid-open No. 64-62974).

Such an image pickup device is constituted as shown in, e.g., FIG. 4, and comprises a first solid-state image pickup element 1a and a first signal processing circuit 2a as a first image pickup system, a second solid-state image pickup element 1b and a second signal processing circuit 2b as a second image pickup system, and a switch circuit 3 and a third signal processing circuit 4.

In the image pickup device shown in FIG. 4, the first and second solid-state image pickup elements 1a and 1b are driven, and image signals of two systems which are taken out from the first and second solid-state image pickup elements 1a and 1b are taken into the first and second signal processing circuits 2a and 2b. The first and second signal processing circuits 2a and 2b perform gamma correction processing or AGC (automatic gain control) processing with respect to image signals of the respective systems, and output the processed signals to the switch circuit 3. The switch circuit 3 takes the image signals of the two systems into respective input terminals, alternately selects these image signals, and outputs a selected image signal to the third signal processing circuit 4. The third signal processing circuit 4 performs processing such as color separation processing or a matrix calculation with respect to the image signal selected by the switch circuit 3, and generates an image signal including a luminance signal and a color difference signal.

In such an image pickup device, image signals of two systems from the first and second solid-state image pickup elements are alternately selected, and signal processing is sequentially performed with respect to a selected image signal in order to combine the image signals, thereby obtaining an image signal of one system in which the first and second image signals are alternately arranged at predetermined intervals.

### DISCLOSURE OF THE INVENTION

It has been disclosed that the above-described image pickup device comprises a plurality of image pickup systems and operations of these image pickup systems are alternately switched. In recent years, it has been considered to apply such an image pickup device to a monitoring camera. Both a solid-state image pickup element suitable for a bright daytime and a solid-state image pickup element suitable for a dark nighttime are mounted and these elements are separately used depending on illumination conditions. When such an image pickup device is applied to a monitoring camera system, the image pickup device is assumed to operate constantly, and each interval of operation switching of the respective solid-state image pickup elements becomes very long, e.g., a several-hour unit. In such an image pickup device, when, e.g., an operating voltage is supplied to the two solid-state image pickup elements, occurrence of current leakage in the solid-state image pickup element or the signal processing circuit which is suspended from operation results in consumption of power irrespective of the fact that the operation of the element or the circuit is suspended. At this time, even if a very small quantity of current leaks, this quantity cannot be ignored in cases where the image pickup device operates continuously for a long time.

It is therefore an object of the present invention to provide, in an image pickup device using a plurality of solid-state image pickup elements, an image pickup device which can efficiently supply an operating voltage and reduce power consumption.

In view of the above-described problems, the present invention is characterized by providing an image pickup device comprising: a first solid-state image pickup element which accumulates first information electric charges generated in response to a first object image in a plurality of light reception pixels; a first drive circuit which obtains a first image signal by driving the first solid-state image pickup element; a second solid-state image pickup element which accumulates second information electric charges generated in response to a second object image in a plurality of light reception pixels; a second drive circuit which obtains a second image signal by driving the second solid-state image pickup element; a timing control circuit which determines timings of vertical scanning and horizontal scanning of the first and second solid-state image pickup elements; and a selector circuit which selectively supplies a predetermined power supply voltage to the first and second solid-state image pickup elements, wherein the first and second solid-state image pickup elements operate in a time-sharing manner, and the power supply voltage is supplied to the solid-state image pickup element which is in an operating state.

According to the present invention, a power supply voltage as an operating voltage is supplied to one of the first and second solid-state image pickup elements which is in the operating state, i.e., an operating solid-state image pickup element only. As a result, the power supply voltage is not supplied to a solid-state image pickup element which is not in the operating state, i.e., a non-operating solid-state image pickup element, and hence unnecessary power consumption is not effected.

### BRIEF DESCRIPTION OF THE DRAWINGS

FIG. 1 is a block diagram showing an embodiment of the present invention;

FIG. 2 is a view showing a structure of output portions of solid-state image pickup elements and circuit configurations of a selector circuit 20 and an output selector circuit 21;

FIG. 3 is a timing chart illustrating an operation of FIG. 2; and

FIG. 4 is a block diagram showing a schematic structure of a conventional image pickup device.

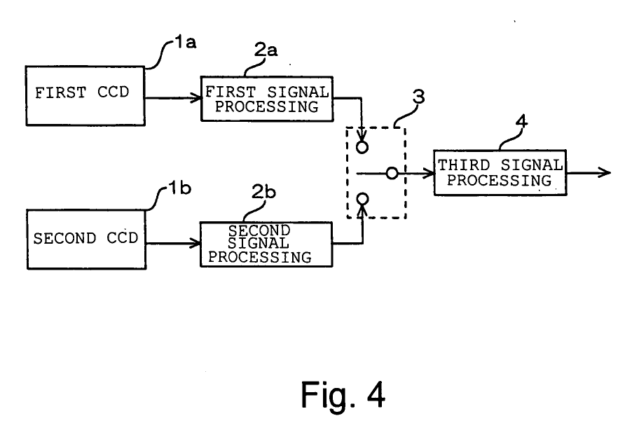

### BEST MODE FOR CARRYING OUT THE INVENTION

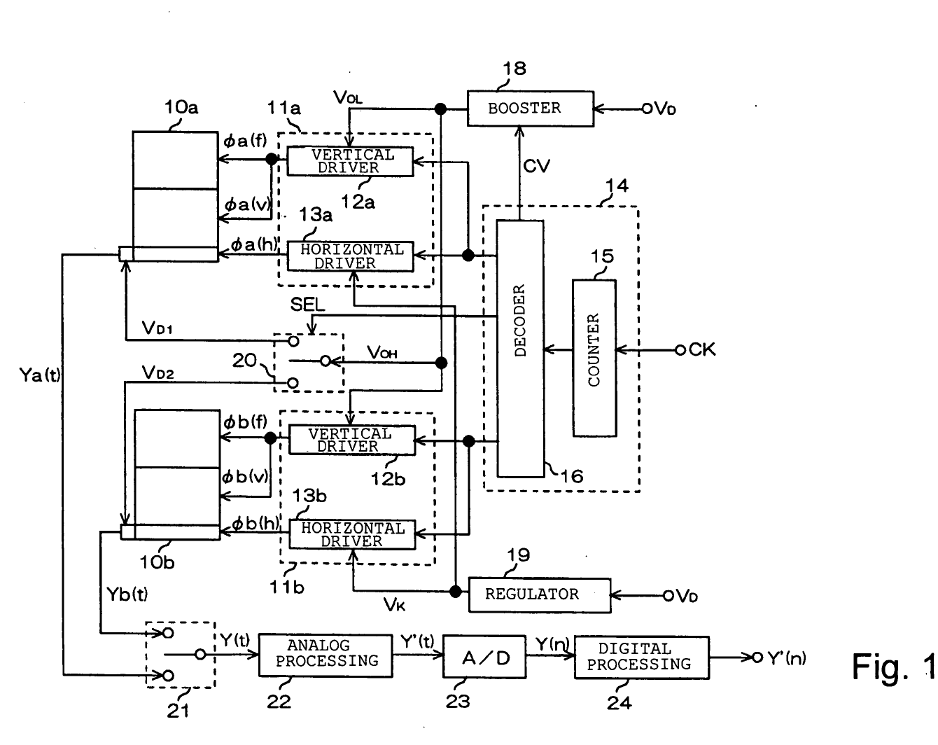

FIG. 1 is a block diagram showing a structure of an image pickup device according to the present invention. In this FIG. 1, a system configuration as an entire image pickup device is shown.

The image pickup device shown in FIG. 1 comprises first and second solid-state image pickup elements 10a and 10b, first and second drive circuits 11a and 11b, a timing control circuit 14, a booster circuit 18, a regulator circuit 19, a selector circuit 20, an output selector circuit 21, an analog processing circuit 22, and an A/D conversion circuit and a digital processing circuit 24.

The first solid-state image pickup element 10a is of, e.g., a frame transfer type, and comprises an image pickup portion, a storage portion, a horizontal transfer portion and an output portion. The image pickup portion has a plurality of light reception pixels arranged in rows and columns, and accumulates information electric charges generated in response to a first object image in each light reception pixel. The storage portion has a plurality of storage pixels arranged in rows and columns, takes information electric charges corresponding to one screen collectively transferred and output from the image pickup portion into each storage pixel, and temporarily accumulates the information electric charges. The horizontal transfer portion receives the information electric charges transferred and output from the storage portion in a one-row unit, and horizontally transfers the information electric charges. The output portion accumulates the information electric charges transferred and output from the horizontal transfer portion in a capacitance in a one-pixel unit, converts the information electric charges into a voltage value according to an electric charge quantity, and outputs this voltage value.

The first drive circuit 11a comprises a first vertical driver 12a and a first horizontal driver 13a. This first drive circuit 11a generates a plurality of drive clocks in response to a timing signal from the timing control circuit 14, and supplies these drive clocks to the first solid-state image pickup element 10a in order to drive the first solid-state image pickup element 10a, thereby taking out a first image signal Y1(t). The first vertical driver 12a generates a frame transfer clock φa(f) and a vertical transfer clock φa(v), supplies these clocks to the image pickup portion and the storage portion, and subjects the first solid-state image pickup element 10a to vertical transfer driving. The first horizontal driver 13a generates a horizontal transfer clock φa(h), supplies this clock to the horizontal transfer portion, and subjects the first solid-state image pickup element 10a to horizontal transfer driving. Further, the first horizontal driver 13a generates a reset clock φa(r), supplies this clock to the output portion, and drives the output portion, thereby taking out a first image signal Ya(t) in a one-pixel unit.

The second solid-state image pickup element 10b is of, e.g., a frame transfer type like the first solid-state image pickup element 10a, and comprises an image pickup portion, a storage portion, a horizontal transfer portion and an output portion.

The second drive circuit 11b has a circuit configuration equivalent to that of the first drive circuit 11a, comprises a second vertical driver 12b and a second horizontal driver 13b, and drives the second solid-state image pickup element 10b in order to take out a second image signal Yb(t).

The timing control circuit 14 supplies timing signals to the first and second drive circuits 11a and 11b so that a vertical scanning timing and a horizontal scanning timing of the first and second solid-state image pickup elements 10a and 10b are determined. This timing control circuit 14 comprises a counter 15 which counts reference clocks CK having a fixed cycle and a decoder 16 which decodes an output from this counter, and can generate a plurality of various timing signals by changing a set value of the decoder 16. Furthermore, the timing control circuit 14 also supplies the timing signals to the selector circuit 20 and the output selector circuits 21 so that operations of the respective circuits are synchronized with operation timings of the first and second solid-state image pickup elements 10a and 10b.

A register (not shown) stores a plurality of set data which are respectively associated with image pickup modes having a plurality of patterns, receives an image pickup mode switching signal MODE supplied from the outside, and outputs set data according to an image pickup mode specified by this signal to the timing control circuit 14. As the image pickup modes associated with the plurality of set data stored in this register, there are, e.g., a mode which operates one of the first and second solid-state image pickup elements 10a and 10b, a mode which switches operations of the first and second solid-state image pickup elements 10a and 10b in units of one screen or a plurality of screens, and others. Moreover, when set data according to these image pickup modes are supplied to the timing control circuit 14, each timing signal is changed in accordance with a specified image pickup mode. For example, when the first and second solid-state image pickup elements 10a and 10b are specified to alternately operate in units of one screen as an image pickup mode, the timing control circuit 14 supplies the timing signal to the drive circuit corresponding to a solid-state image pickup element to be operated alone, and stops supply of the timing signal to the other drive circuit. Thereafter, when acquisition of image signals corresponding to one screen from the operated solid-state image pickup element is completed, the drive circuit to which the timing signal is supplied is switched, and the other solid-state image pickup element is operated.

The booster circuit 18 is provided in common with the first and second solid-state image pickup elements 10a and 10b, boosts a power supply voltage supplied from a battery (not shown) in response to a booster clock CV to generate a booster voltage, and outputs this voltage to the first and second drive circuits 11a and 11b. This booster circuit 18 has a positive side booster circuit which boosts the fetched voltage to a positive side and a negative side booster circuit which boosts the same to a negative side, and outputs a booster voltage V_{OH} generated in the positive side booster circuit to the selector circuit 20 and a booster voltage V_{OL} generated in the negative side booster circuit to the first and second vertical drivers 12a and 12b.

The regulator circuit 19 is provided in common with the first and second solid-state image pickup elements 10a and 10b, takes in a power supply voltage supplied from, e.g., a battery in order to generate a predetermined regulation voltage V_{K}, and outputs this voltage to the first and second horizontal drivers 13a and 13b. This regulator circuit 19 compares a divided voltage obtained by subjecting the power supply voltage supplied thereto to resistance division with a predetermined reference voltage in a comparator, and generates the adjustment voltage V_{K} based on an output from the comparator. In the regulator circuit 19, a voltage value of the regulation voltage is set in accordance with operating voltages of the horizontal drivers 13a and 13b on a next stage, and an output is regulated in such a manner that the power supply voltage from the battery is lowered to the adjustment voltage V_{K}.

The selector circuit 20 takes in the booster voltage V_{OH} from the booster circuit 18, and selectively outputs the booster voltage V_{OH} to the first and second solid-state image pickup elements 10a and 10b in response to a selection signal SEL. The selection signal SEL supplied to this selector circuit 20 is generated in accordance with an image pickup mode by the timing control circuit 14, and hence the booster voltage V_{OH} is supplied to one of the first and second solid-state image pickup elements 10a and 10b in synchronization with operation timing of the first and second solid-state image pickup elements 10a and 10b. For example, when the first solid-state image pickup element 10a alone is operated, the booster voltage V_{OH} is supplied to the first solid-state image pickup element 10a alone, and supply of the booster voltage V_{OH} to the second solid-state image pickup element 10b is interrupted.

The output selector circuit 21 takes in the first and second image signals Ya(t) and Yb(t), selects one of the first and second image signals Ya(t) and Yb(t) in synchronization with operation timing of the first and second solid-state image pickup elements 10a and 10b, and outputs the selected signal as an image signal Y(t).

The analog processing circuit 22 performs analog signal processing such as CDS or AGC with respect to the image signal Y(t) selected by the output selector circuit 21. In CDS, an image signal whose signal level is continuous is generated in such a manner that a reset level is clamped and a signal-level is then taken out with respect to the image signal Y(t) which alternately repeats the reset level and the signal level. Additionally, in AGC, the image signal taken out by CDS is integrated for one screen or in units of one vertical scanning period, and gain adjustment is carried out in such a manner that an integrated value falls within a predetermined range.

The A/D conversion circuit 23 takes in and standardizes an image signal Y′(t) subjected to analog signal processing, converts it from an analog signal into a digital signal, and outputs the converted signal as image data Y(n).

The digital processing circuit 24 performs digital signal processing such as color separation, a matrix calculation or the like with respect to the image data Y(n) output from the A/D conversion circuit 23, and generates image data Y′(n) including a luminance signal and a color difference signal. Further, digital processing circuit 24 has an exposure control circuit or a white balance control circuit, and performs an exposure control which controls exposure states of the first and second solid-state image pickup elements 10a and 10b and a white balance control which controls a white balance of the image signal Y(t).

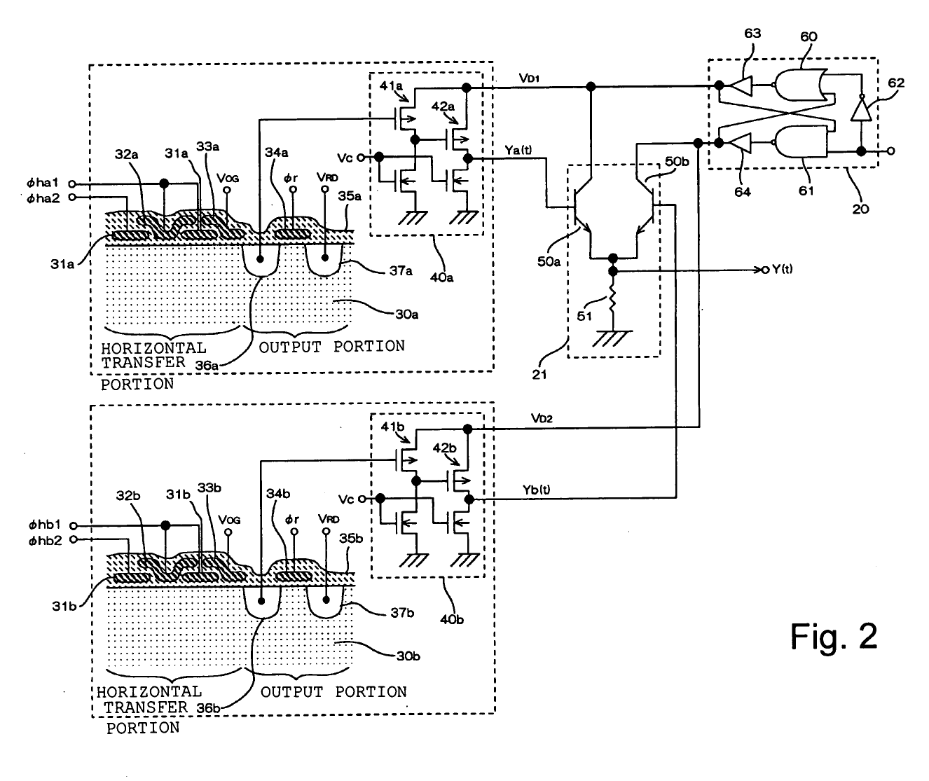

FIG. 2 is a view showing structures of the horizontal transfer portion and the output portion of each of the first and second solid-state image pickup elements 10a and 10b, and structures of the selector circuit 20 and the output selector circuit 21. It is to be noted that like reference numerals denote parts equivalent to those in FIG. 1.

In the first solid-state image pickup element 10a, a plurality of transfer electrodes 31a and 32a are arranged in multilayer form on a first silicon substrate 30a through an insulating film 35a, thereby constituting the horizontal transfer portion. In this horizontal transfer portion, information electric charges are transferred in a channel area formed below the transfer electrodes in accordance with horizontal transfer clocks φh1 and φh2 applied to the respective transfer electrodes 31a and 32a. A first output gate electrode 33a to which a first output gate voltage V_{OG} is applied is arranged on the output side of the horizontal transfer portion, and the output portion is formed to be adjacent to this first output gate electrode 33a. A first floating diffusion (first capacitance) 36a is formed in a surface area of the first silicon substrate 30a of the output portion. The information electric charges transferred and output from the horizontal transfer portion are temporarily accumulated in this first floating diffusion 36a. The first floating diffusion 36a is connected with an input terminal of a first output amplifier 40a, and a change in potential of the first floating diffusion 36a according to an accumulated electric charge quantity of the information electric charges is thereby taken out by the first output amplifier 40a. A first reset drain 37a to which a drain voltage V_{RD} is applied is formed in a surface area of the first silicon substrate 30a apart from the first floating diffusion 36a by a fixed distance. Both the first floating diffusion 36a and the first reset drain 37a are formed by implanting N type impurities in the surface area of the first silicon substrate 30a with a high concentration. Further, a reset electrode 34a to which a reset clock φr is applied is formed in an area between the first floating diffusion 36a and the first reset drain 37a, thereby constituting a reset transistor. This reset transistor achieves electrical conduction between the first floating diffusion 36a and the first reset drain 37a in response to the reset clock φr, and discharges the information electric charges accumulated in the first floating diffusion 36a to the first reset drain 37a.

The first output amplifier 40a comprises, e.g., source follower circuits 41a and 42a on two stages, and a fluctuation in potential of the first floating diffusion 36a is received by the input side of the source follower circuit 41a on the first stage. This first output amplifier 40a operates upon receiving the booster voltage V_{OH} supplied through the selector circuit 20, and the fluctuation in potential of the first floating diffusion 36a received on the input side is subjected to impedance conversion, thereby obtaining an output signal. Each of the source follower circuits 41a and 42a has two MOS transistors connected in series between a power supply terminal which receives the booster voltage V_{OH} and a ground point, and has a gate of the MOS transistor on the power supply terminal side as an input and a connection point between the two MOS transistors connected in series as an output. Furthermore, a gain of each of the source follower circuits 41a and 42a is set in accordance with a control voltage V_{c} supplied to the gate of the MOS transistor on the ground side. The first image signal Ya(t) which is output in response to a fluctuation in potential of the first floating diffusion 36a is output from this output amplifier 40a.

The second solid-state image pickup element 10b has a second floating diffusion 36b, a second reset drain 37b and a second output amplifier 40b. This second solid-state image pickup element 10b has a structure equivalent to that of the first solid-state image pickup element 10a, and the explanation thereof will be eliminated here.

The selector circuit 20 comprises first and second NAND gates 60 and 61, first and second buffers 63 and 64, and an inverter 62. The first and second NAND gates 60 and 61 are cross-coupled with each other, an output from the first NAND gate 60 is applied to one input of the second NAND gate 61, and an output from the second NAND gate 61 is applied to one input of the first NAND gate 60. A selection signal SEL from the timing control circuit 14 is applied to the other input terminal of the second NAND gate 61, and a logical product output obtained from the selection signal SEL and the output of the first NAND gate 60 is output to the first buffer 63 from the second NAND gate 61. On the other hand, a reversed signal obtained by reversing the selection signal SEL by the inverter 62 is applied to the other input terminal of the first NAND gate 60, and a logical product output obtained from the reversed signal and the output of the second NAND gate 61 is output to the second buffer 64 from the first NAND gate 60. Further, each of the NAND gates 60 and 61 comprises a plurality of MOS transistors connected between the power supply terminal which receives the booster voltage V_{OH} and the ground point, outputs one of the booster voltage V_{OH} and the ground voltage V_{G}, and holds this output by cross-coupling connected.

The output selector circuit 21 comprises first and second transistors 50a and 50b and a resistance element 51. The first and second transistors 50a and 50b are respectively provided in accordance with the first and second solid-state image pickup elements 10a and 10b, the first transistor 50a and the resistance element 51 constitute a first input path, and the second transistor 50b and the resistance element 51 constitute a second input path. The first and second transistors 50a and 50b comprise, e.g., bipolar transistors, and receive outputs from the first and second output amplifiers 40a and 40b at base terminals thereof. In the output selector circuit 21, therefore, only a transistor which receives an output from an operating solid-state image pickup element of the first and second transistors 50a and 50b is activated, and an output from the operating solid-state image pickup element is thereby output to a circuit on a next stage.

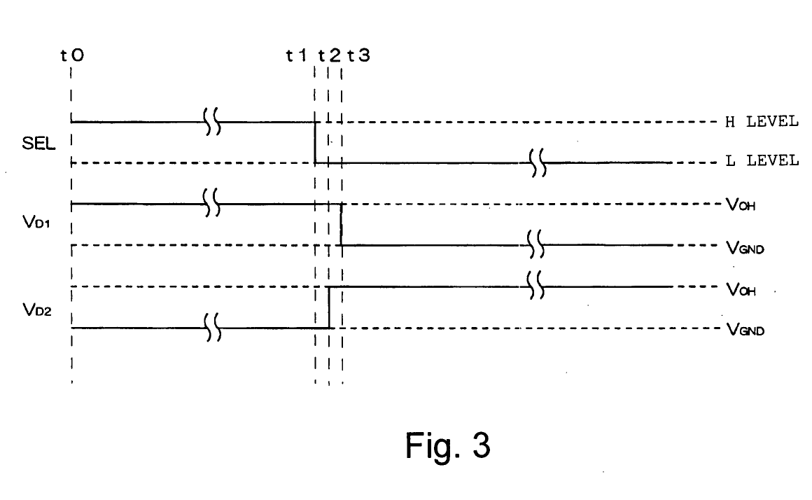

FIG. 3 is a timing chart illustrating the operation of FIG. 2. This FIG. 3 shows the selection signal SEL, and supply voltages V_{D}1 and V_{D}2 to the first and second output amplifiers 40a and 40b. In this drawing, times t0 to t1 correspond to an operating period of the first solid-state image pickup element 10a, a time t3 and subsequent times correspond to an operating period of the second solid-state image pickup element 10b, and times t1 to t3 correspond to a transition period of operation switching from the first solid-state image pickup element 10a to the second solid-state image pickup element 10b.

At the times t0 to t1, when the selection signal is at an H level, an output from the first NAND gate 60 is changed to the H level (booster voltage V_{OH}) and an output from the second NAND gate 61 is changed to an L level (ground voltage V_{GND}) in the selector circuit 20. As a result, the booster voltage V_{OH} is supplied to the first output amplifier 40a and the first transistor 50a, the ground voltage V_{GND} is supplied to the second output amplifier 40b and the second transistor 50b, and power is supplied to the operating solid-state image pickup element alone.

At the time t1, when the selection signal SEL is changed to the L level, an output from the first NAND gate 60 is changed to the L level (ground voltage V_{GND}) and an output from the second NAND gate 61 is changed to the H level (booster voltage V_{OH}) in the selection circuit 20. At this time, in the first NAND gate 60, an output is switched at the time t2 which is delayed for a delay time of the first NAND gate 60 itself with respect to the time t1 at which the selection signal SEL is changed to the lower level. Further, in the second NAND gate 61, an output is switched at the time t3 which is delayed for a delay time of the second NAND gate itself with respect to the time t2 at which an output from the first NAND gate 60 is switched. As a result, in the period in which the booster voltage V_{OH} is supplied to the second output amplifier 40b and the second transistor 50b, the delay time of the first NAND gate 60 overlaps the period in which the booster voltage V_{OH} is supplied to the first output amplifier 40a and the first transistor 50a.

In this manner, when switching supply of the power, providing a fixed transition period can obtain a stable image signal. For example, when supply of the power to the first and second solid-state image pickup elements 10a and 10b is instantaneously switched, since the operation is shifted in the solid-state pickup element which has been suspended in a state where the DC level is yet to be changed to a higher level, the signal immediately after switching becomes unstable, and hence the image signal cannot be correctly taken out in some cases. Therefore, by taking out the image signal after the DC level of the solid-state image pickup element becomes sufficiently stable, the stable image signal can be obtained even immediately after switching of supply of the power.

Moreover, when an output from the second NAND gate 61 is changed to the L level at the timing t3, the booster voltage V_{OH} is supplied to the second output amplifier 40b and the second transistor 50b, the ground voltage V_{GND} is supplied to the first output amplifier 40a and the first transistor 50a and the power is supplied to the second solid-state image pickup element 10b only after this time.

In this manner, the power can be efficiently supplied to the first and second solid-state image pickup elements 10a and 10b by switching supply of the power to the first and second solid-state image pickup elements 10a and 10b in synchronization with operation switching of the first and second solid-state image pickup elements 10a and 10b. That is, the power is supplied to the operating solid-state image pickup element alone, and the power is not supplied to the solid-state image pickup element which has stopped operating. Therefore, unnecessary power can be prevented from being consumed in the solid-state image pickup element under suspension, thereby reducing power consumption as the image pickup device. It is to be noted that the booster voltage V_{OL} is constantly supplied to the first and second drive circuits 11a and 11b from the booster circuit 18, but the first and second drive circuits 11a and 11b do not operate unless the timing signal from the timing control circuit 14 is supplied thereto. Therefore, even if the booster voltage is supplied, the power is not consumed in the drive circuit corresponding to the inactivated solid-state image pickup element.

The above has described the embodiment according to the present invention with reference to FIGS. 1 to 3. In this embodiment, the booster voltage V_{OH} is supplied to the selector circuit 20 and the output selector circuit 21 as the power supply voltage, but the present invention is not restricted thereto. If the first and second solid-state image pickup elements 10a and 10b operate with the power supply voltage supplied from a battery, it is possible to adopt a structure in which this power supply voltage is supplied to the selector circuit 20 and the output selector circuit 21.

Additionally, although the frame transfer type has been taken as an example of a type of the solid-state image pickup element, the present invention is not restricted thereto, and the present invention can be suitably applied even to an image pickup device using solid-state image pickup elements which are of an interline type or a frame interline type as other transfer types.

According to the present invention, in the image pickup device using the plurality of solid-state image pickup elements, the power can be efficiently supplied to the plurality of solid-state image pickup elements, thereby achieving low power consumption.

1. An image pickup device comprising: a first solid-state image pickup element which accumulates first information electric charges generated in response to a first object image in a plurality of light reception pixels; a first drive circuit which obtains a first image signal by driving the first solid-state image pickup element; a second solid-state image pickup element which accumulates second information electric charges generated in response to a second object image in a plurality of light reception pixels; a second drive circuit which obtains a second image signal by driving the second solid-state image pickup element; a timing control circuit which determines timing of vertical scanning and horizontal scanning of the first and second solid-state image pickup elements; and a selector circuit which selectively supplies a predetermined power supply voltage to the first and second solid-state image pickup elements, wherein the first and second solid-state image pickup elements operate in a time-sharing manner, and the power supply voltage is supplied to the solid-state image pickup element which is in an operating state.

2. The image pickup device according to claim 1, wherein the selector circuit overlaps a part of a period in which the power supply voltage is supplied to one of the first and second solid-state image pickup elements with respect to a period in which the power supply voltage is supplied to the other one of the first and second solid-state image pickup elements.

3. The image pickup device according to claim 1, wherein the first solid-state image pickup element comprises a first capacitance which takes in and accumulates the first information electric charges which are transferred and output and a first output amplifier which takes out a change in potential of the first capacitance according to an accumulated electric charge quantity of the first information electric charges and outputs the first image signal, the second solid-state image pickup element comprises a second capacitance which takes in and accumulates the second information electric charges which are transferred and output and a second output amplifier which takes out a change in potential of the second capacitance according to an accumulated electric charge quantity of the second information electric charges and outputs the second image signal, and the selector circuit supplies the power supply voltage to the output amplifier of the solid-state image pickup element which is in an operating state of the first and second output amplifiers.

4. The image pickup device according to claim 3, wherein the selector circuit overlaps a part of a period in which the power supply voltage is supplied to one of the first and second output amplifiers with respect to a period in which the power supply voltage is supplied to the other one of the first and second output amplifiers.

5. The image pickup device according to claim 1, further comprising an output selector circuit which takes in the first and second image signals and selectively outputs the first and second image signals to a processing circuit on a next stage in synchronization with operation timing of the first and second solid-state image pickup elements, wherein the output selector circuit has a plurality of input paths respectively corresponding to the first and second image signals, each input path operates upon receiving the power supply voltage, and the selector circuit selectively supplies the power supply voltage to each of the plurality of input paths in synchronization with the operation timing of the first and second solid-state image pickup elements.

6. The image pickup device according to claim 5, wherein the selector circuit overlaps a part of a period in which the power supply voltage is supplied to one of the plurality of input paths with respect to a period in which the power supply voltage is supplied to the other one of the plurality of input paths.
